(19) United States
(12) Patent Application Publication
(10) Pub. No.: US 2026/0103127 A1
(43) Pub. Date: Apr. 16, 2026

(54) COMFORT SYSTEM RETENTION ASSEMBLIES AND METHODS

(71) Applicant: LEAR CORPORATION, Southfield, MI (US)

(72) Inventors: Timothy M. Cloutier, Clawson, MI (US); Ashley Baisch, Washington Township, MI (US); Samuel Blair, Rochester, MI (US)

(21) Appl. No.: 18/911,933

(22) Filed: Oct. 10, 2024

(51) Int. Cl. B60N 2/58

(52) U.S. Cl. CPC B60N 2/5866; B60N 2/5891

(57) ABSTRACT

An assembly includes a trim cover assembly and a comfort layer. A retention fastener includes a stem and a crossbar, and the stem is joined to one of the trim layer and the comfort layer at a joining point. The other of the trim layer and the comfort layer includes an opening, and the retention fastener received through the opening with the crossbar opposite the opening from the joining point.

### BACKGROUND

Vehicle seat assemblies may be provided with trim covers formed from one or more panels and positioned over cushions.

### BRIEF DESCRIPTION OF THE DRAWINGS

FIG. 1 is a perspective view of an example seat assembly.

FIG. 2 illustrates a portion of the example seat assembly.

FIG. 3 illustrates a portion of the example seat assembly.

FIG. 4 illustrates a portion of the example seat assembly.

FIG. 5 illustrates an example cushion of the example seat assembly.

FIG. 6A illustrates an example retention fastener shape.

FIG. 6B illustrates another example retention fastener shape.

FIG. 6C illustrates another example retention fastener shape.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to a seat assembly utilizing a retention fastener to attach one or more layers to one or more other layers. The disclosed assemblies may be relatively low cost, and relatively easy to manufacture and assemble.

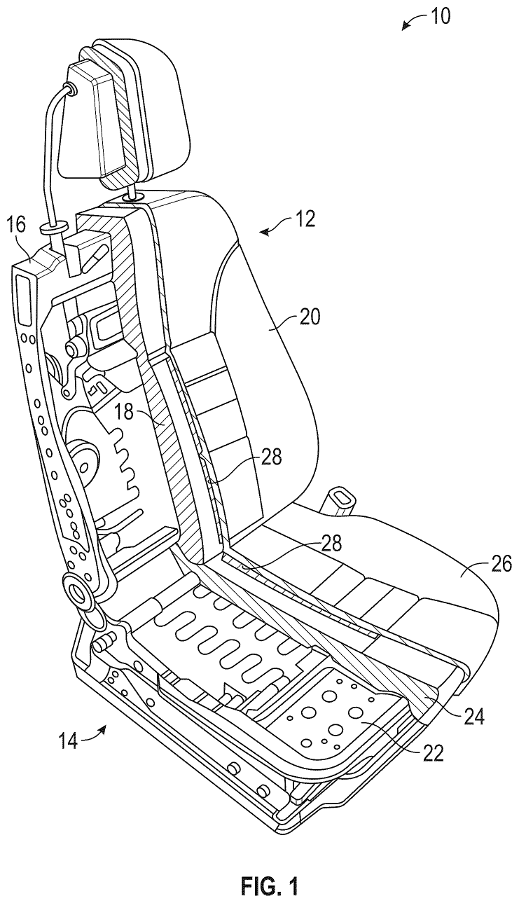

FIG. 1 illustrates an example seat assembly 10. The seat assembly 10 may be utilized as a vehicle seat assembly 10 for seating in a vehicle, such as an automobile, an aircraft, a watercraft, or any other seating environment. In this example, the seat assembly 10 includes a seat back 12 and a seat bottom 14, which may be adapted to be mounted for motor-driven adjustable translation in a fore and aft direction and in an up and down direction of a vehicle. The seat back 12 includes a seat frame 16. The seat back 12 may be pivotally connected to the seat bottom 14 to extend generally upright relative to the seat bottom 14 for pivotal adjustment about an axis relative to the seat bottom 14. The seat frame 16 supports a cushion 18, which is covered by a trim cover assembly 26. The seat bottom 14 likewise includes a seat frame 22, which supports a cushion 24.

In some implementations, the seat assembly 10 may be shaped and sized as a front row driver or passenger seat, a second, third, or other rear row seat, and may include bench-style seats, bucket seats, or other seat styles. Furthermore, the seat assembly 10 may be a non-stowable seat or a stowable seat that may be foldable and stowable in a cavity in the vehicle floor. Additionally, the seat assembly 10 may be configured for use with other non-vehicle applications.

The seat frame 16 may be made of metal, plastic, wood, or a combination thereof. The seat frame 16 may be made of steel and/or aluminum in some implementations.

The seat bottom 14 may be configured to support a seat occupant. In a vehicular application, the seat bottom 14 may be mounted to a support surface, such as a vehicle floor. It should be understood that this is just one example of a seat configuration, and that other configurations could also be utilized.

Each cushion 18, 24 may be one or more foam parts, joined together to form the seat component. For example, the seat back cushion 18 may include a main seating portion and various bolster portions. The cushions 18, 24 can have any suitable size and be formed from any suitable configuration of components. In implementations, the cushions 18,24 form a contoured shape, e.g., a concave shape, for a corresponding occupant seating surfaces, with the concavity of the cushions 18, 24 improving occupant comfort and aesthetic styling of the seat assembly 10. The cushions 18, 24 can independently comprise any suitable comfort foam material such as, but not limited to, a suitable resilient polymer, and can independently be formed in any suitable manner. For example, the cushions 18, 24 may be formed of conventional polyurethane foam, soy-based foam, silicone, thermoplastic olefins, thermoplastic urethanes, and/or natural oil-based expanded polyurethanes, soy-based polyurethane, polymer fibers, non-woven polyester pads, latex foams and the like. The foam cushions 18, 24 are formed of any suitable comfort material that provides soft resilience as the seat assembly is deflected during use when an occupant is in a seated position.

In implementations, a trim cover assembly 26 may be disposed over or upon the cushions 18, 24. The trim cover assembly 26 provides at least a portion of a visible exterior surface of the seat assembly 10. In implementations, the trim cover assembly 26 may include a plurality of trim panels that may be assembled in any suitable manner, such as by stitching. The trim panels may be made of any suitable material or materials, such as a fabric, woven fabric, faux leather, or leather surface; includes cotton, polyester, polyurethane, nylon, or any other suitable material, or combinations thereof. The trim cover assembly 26 may be the outermost layer of the seat assembly 10. The trim cover assembly 26 may provide a seating surface for the seat assembly 10. The trim cover assembly 26 may be formed from one or more trim panels of a fabric, leather, leatherette, vinyl, or other upholstery material. Two adjacent trim panels may be sewn or otherwise connected to one another, e.g. via welding or the like, along a seam.

One or more comfort layers 28 may be provided between the trim cover assembly 26 and the cushions 18, 24. In some implementations, the comfort layer 28 may be a heat mat, which may provide warmth and comfort to the vehicle occupant. The heat mat may include a thin, flexible heating element, and, when activated, may generate heat that radiates through the seat surface, warming the occupant. In some implementations, the heat mat may include polyester felt. In some implementations, the heat mat may include unreticulated foam with scrim, such as warp knit or circular scrim. In some implementations, the comfort layer 28 may be a massage assembly including one or more massage bladders for providing a massage to the vehicle occupant.

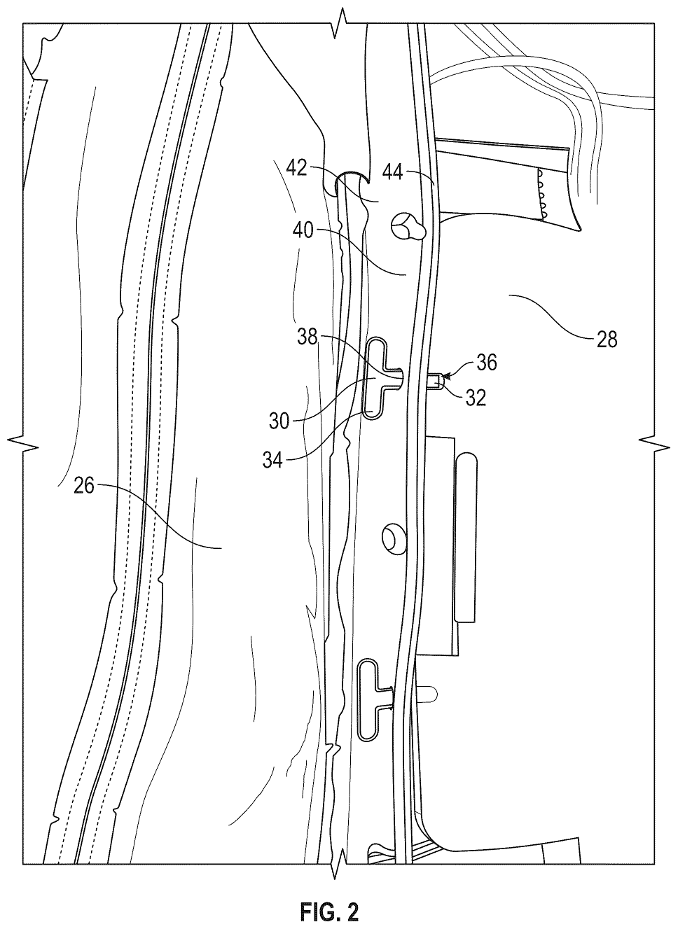

As shown in FIGS. 2-4, one or more layers of the seat assembly 10 may be attached to one another using the retention fasteners 30. For example, the trim cover assembly 26 may be attached to the comfort layer 28. In some implementations, this may be done before the trim cover assembly 26 and comfort layer 28 are positioned over or upon the cushions 18, 24. In some implementations, two comfort layers may be attached to one another in any of the ways described herein.

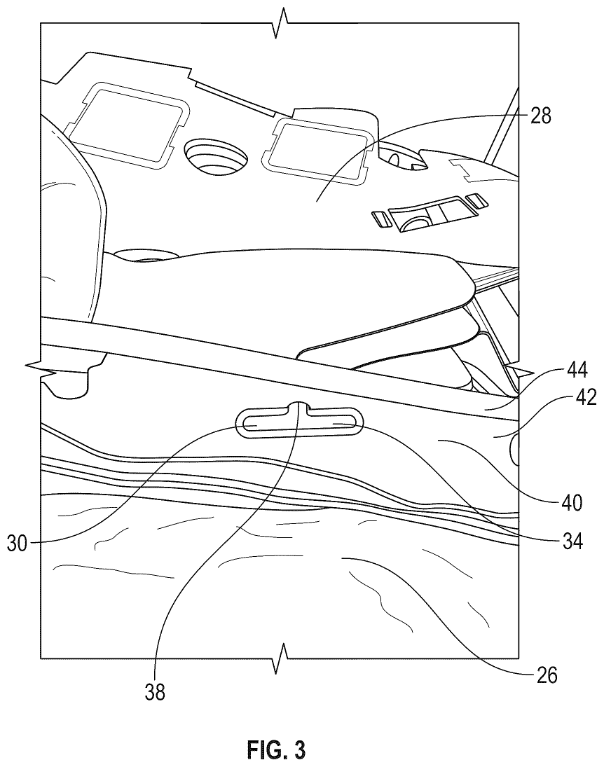

As illustrated in FIGS. 2 and 3, a retention fastener 30 may include a stem 32 and a crossbar 34. The stem 32 may be joined (e.g., welded, fastened with additional fasteners, or otherwise integrated into the layer) to one of the trim cover assembly 26 and comfort layer 28 at a joining point 36, and the other of the trim layer and the comfort layer includes an opening 38 for receiving the retention fastener 30. In some implementations, the stem 32 may be joined to a layer before the fastener 30 is pushed through an opening 38. The crossbar 34 may be opposite the opening 38 from the joining point 36 when the retention fastener 30 is received within the opening 38.

In some implementations, one or more openings 38 may be provided in a tie down 40 of the trim cover assembly 26. The tie down 40 may include a strip of upholstery 42 and a beaded duon extrusion 44, with the one or more openings 38 provided in the upholstery 42. The upholstery 42 may be stitched or otherwise attached to the B-side of the upholstery forming the trim cover portion of the trim cover assembly 26. Other tie down configurations may benefit from this disclosure. The crossbar 34 may be received against a surface of the tie down 40, and the stem 32 extends through the opening 38 and through an opposite surface of the tie down 40 to the joining point 36. In some implementations, there is a benefit to using the tie down 40 for the one or more openings 38 because the tie down 40 is an existing feature in the trim cover assembly 26.

In some implementations, the stem 32 may be welded or otherwise joined (e.g., fasteners, grommets, two-piece rivets, or integrated into the layer) to the comfort layer 28 at the joining point 36. The welds may be formed using any technique, such as high-frequency welding. The retention fastener 30 may be placed within the opening 38 with the crossbar 34 opposite the opening 38 from the joining point 36. The crossbar 34 creates a physical barrier that prevents the fastener 30 from slipping back through the opening 38, thereby securing the trim cover assembly 26 to the comfort layer 28.

The stem 32 may be joined to the comfort layer 28 near the perimeter of the comfort layer 28. The stem 32 may be joined to the comfort layer 28 at multiple points near the perimeter of the comfort layer 28.

As illustrated in FIG. 4, the trim cover assembly 26 may be attached to the comfort layer 28 using the fasteners 30 at multiple attachment points P. In some implementations, the attachment points P may be provided at two tie downs 40 at opposing lateral sides of the comfort layer 28, which may result in maintained fixation during transportation, assembly, and seat usage. That is, with reference to FIGS. 2 and 3, each tie down 40 may include one or more openings 38 for receiving one or more fasteners 30. The comfort layer 28 may be flanked by two tie downs 40 at opposing lateral sides and attached to each tie down 40.

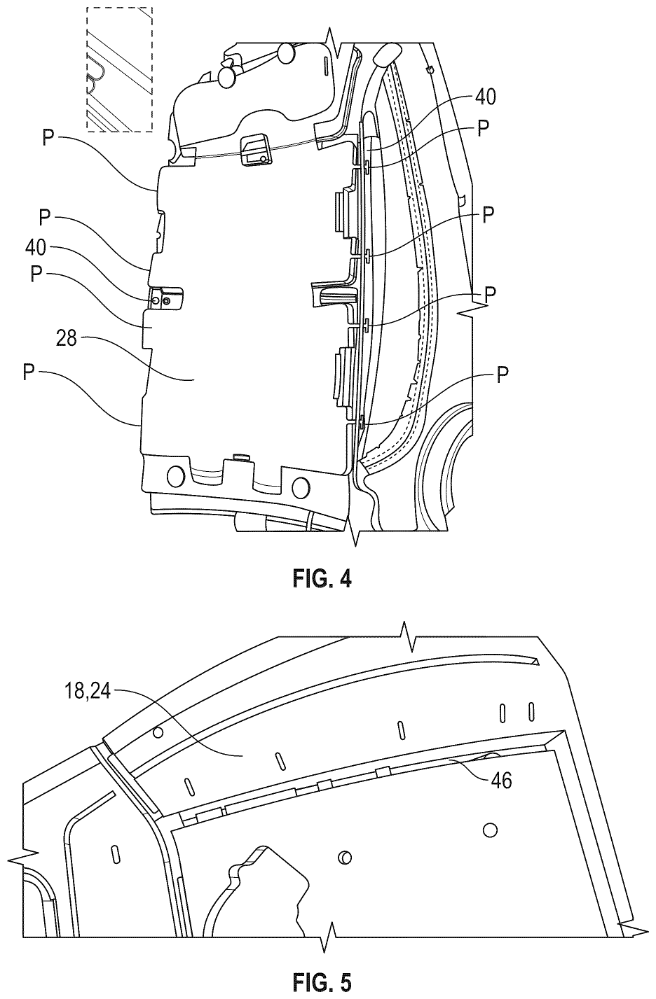

As illustrated in FIG. 5, with continued reference to FIGS. 2-4, the tie down(s) 40 may be positioned within one or more corresponding grooves 46 of the cushions 18, 24.

In some implementations, the retention fastener 30 may be a polymeric material. In some implementations, the retention fastener 30 may be plastic. In some implementations, the retention fastener 30 may be thermoplastic polyurethane (TPU). In some implementations, the retention fastener may be a material suitable to withstand the pullout force imparted on the assembly via transportation, assembly, and seat durability.

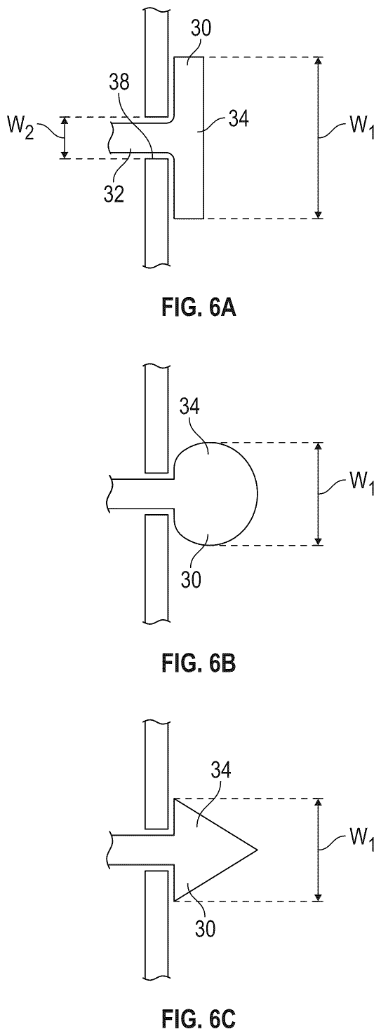

As shown in FIG. 6A, the retention fastener 30 may be T-shaped, with the stem 32 formed by the vertical portion of the “T” and the crossbar 34 formed by the horizontal portion of the “T.” Other shapes are contemplated, including any shape that retains the comfort layer during the entire product life cycle. The crossbar 34 may have a maximum width w1 greater than a maximum width w2 of the opening 38 to prevent the fastener 30 from slipping back through the opening 38 during normal use of the seat assembly 10. The crossbar 34 may have a maximum width w1 greater than a maximum width of the stem 32. The fastener 30 may be turned, rotated, flexed, or combinations thereof to feed the crossbar 34 through the opening 38 during an attachment process. In some implementations, one end of the crossbar 34 may be fed through the opening 38, and then a second, opposite end of the crossbar 34 may be fed through the opening 38 during the attachment process.

As another example, as shown in FIG. 6B, the crossbar 34 may be circular or otherwise round in shape. As another example, in FIG. 6C, the crossbar 34 may be chevron shaped. The crossbar 34 may have a suitable width w1 that prevents the fastener 30 from slipping back through the opening 38 during normal use.

The examples disclosed herein may be utilized to attach two layers of a seat assembly 10 together without additional mechanical clips, double sided tape, or other fasteners added. The examples disclosed may be utilized to reduce costs and/or assembly time and/or service time.

A method, in accordance with any of the examples disclosed herein, may be said to include joining a stem 32 of a retention fastener 30 to one of a comfort layer 28 and a trim cover assembly 26 at a joining point 36; and pushing the retention fastener 30 through an opening 38 in the other of the comfort layer 28 and the trim cover assembly 26 such that a crossbar 34 of the retention fastener 30 is opposite the opening 38 from the joining point 36.

The joining step may include welding the stem 32 to the comfort layer 28 or the trim cover assembly 26. The method may include positioning the trim cover assembly 26 and the comfort layer 28 onto a seat cushion 18, 24. The opening 38 may be provided in a tie down 40 of the trim cover assembly 26. The method may include attaching the tie down 40 to a seat cushion 18, 24.

Additionally or alternatively, a method may include joining a stem 32 of a retention fastener 30 to one comfort layer 28 at a joining point 36, and pushing the retention fastener 30 through an opening 38 in another comfort layer 28 such that a crossbar 34 of the retention fastener 30 is opposite the opening 38 from the joining point 36.

An assembly may include a trim cover assembly; a comfort layer; and a retention fastener including a stem and a crossbar. The stem is joined to one of the trim layer and the comfort layer at a joining point, the other of the trim layer and the comfort layer includes an opening, and the retention fastener received through the opening with the crossbar opposite the opening from the joining point.

In some implementations, the assembly includes a seat frame; and a seat cushion supported by at least a portion of the seat frame. The trim layer is positioned over the seat cushion.

In some implementations, the comfort layer is positioned between the seat cushion and the trim cover assembly.

In some implementations, the comfort layer is a heat mat.

In some implementations, the retention fastener is T-shaped.

In some implementations, the retention fastener includes thermoplastic polyurethane.

In some implementations, the stem is welded to the comfort layer.

In some implementations, the opening is provided in a tie down of the trim cover assembly.

In some implementations, the assembly includes a seat frame; and a seat cushion supported by at least a portion of the seat frame. The trim layer is positioned over the seat cushion, the comfort layer is a heat mat positioned between the seat cushion and the trim layer, the retention fastener is T-shaped and includes thermoplastic polyurethane, the stem is welded to the heat mat, and the opening is provided in a tie down of the trim cover assembly.

In some implementations, the comfort layer is a heat mat, the retention fastener is T-shaped and includes thermoplastic polyurethane, the stem is welded to the heat mat, and the opening is provided in a tie down of the trim cover assembly.

A method may include joining a stem of a retention fastener to one of a comfort layer and a trim cover assembly at a joining point; and pushing the retention fastener through an opening in the other of the comfort layer and the trim cover assembly, such that a crossbar of the retention fastener is opposite the opening from the joining point.

In some implementations, the joining step includes welding the stem to the comfort layer.

In some implementations, the opening is provided in a tie down of the trim cover assembly.

In some implementations, the method includes attaching the tie down to a seat cushion.

In some implementations, the retention fastener is T-shaped and includes thermoplastic polyurethane.

In some implementations, the method includes positioning the trim cover assembly and the comfort layer onto a seat cushion.

In some implementations, the opening is provided in a tie down of the trim cover assembly.

In some implementations, the method includes attaching the tie down to the seat cushion.

In some implementations, the comfort layer is a heat mat.

In some implementations, the joining step includes welding the stem to the comfort layer, the opening is provided in a tie down of the trim cover assembly, the retention fastener is T-shaped and includes thermoplastic polyurethane, and the comfort layer is a heat mat, the method including: positioning the trim cover assembly and the comfort layer onto a seat cushion; and attaching the tie down to the seat cushion.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly, comprising:
a trim cover assembly;
a comfort layer; and
a retention fastener including a stem and a crossbar, wherein the stem is joined to one of the trim cover assembly and the comfort layer at a joining point, the other of the trim cover assembly and the comfort layer includes an opening, and the retention fastener received through the opening with the crossbar opposite the opening from the joining point.

2. The assembly of claim 1, comprising:
a seat frame; and
a seat cushion supported by at least a portion of the seat frame, wherein the trim cover assembly is positioned over the seat cushion.

3. The assembly of claim 2, wherein the comfort layer is positioned between the seat cushion and the trim cover assembly.

4. The assembly of claim 3, wherein the comfort layer is a heat mat.

5. The assembly of claim 1, wherein the retention fastener is T-shaped.

6. The assembly of claim 5, wherein the retention fastener comprises thermoplastic polyurethane.

7. The assembly of claim 1, wherein the stem is welded to the comfort layer.

8. The assembly of claim 7, wherein the opening is provided in a tie down of the trim cover assembly.

9. The assembly of claim 1, comprising:
a seat frame; and
a seat cushion supported by at least a portion of the seat frame, wherein the trim cover assembly is positioned over the seat cushion,
wherein the comfort layer is a heat mat positioned between the seat cushion and the trim cover assembly,
the retention fastener is T-shaped and comprises thermoplastic polyurethane,
the stem is welded to the heat mat, and
the opening is provided in a tie down of the trim cover assembly.

10. The assembly of claim 1, wherein the comfort layer is a heat mat,
the retention fastener is T-shaped and comprises thermoplastic polyurethane, the stem is welded to the heat mat, and
the opening is provided in a tie down of the trim cover assembly.

11. A method, comprising:
joining a stem of a retention fastener to one of a comfort layer and a trim cover assembly at a joining point; and
pushing the retention fastener through an opening in the other of the comfort layer and the trim cover assembly, such that a crossbar of the retention fastener is opposite the opening from the joining point.

12. The method of claim 11, wherein the joining step includes welding the stem to the comfort layer.

13. The method of claim 12, wherein the opening is provided in a tie down of the trim cover assembly.

14. The method of claim 13, comprising:
attaching the tie down to a seat cushion.

15. The method of claim 12, wherein the retention fastener is T-shaped and comprises thermoplastic polyurethane.

16. The method of claim 11, comprising:
positioning the trim cover assembly and the comfort layer onto a seat cushion.

17. The method of claim 16, wherein the opening is provided in a tie down of the trim cover assembly.

18. The method of claim 17, comprising:
attaching the tie down to the seat cushion.

19. The method of claim 16, wherein the comfort layer is a heat mat.

20. The method of claim 11, wherein the joining step includes welding the stem to the comfort layer, the opening is provided in a tie down of the trim cover assembly, the retention fastener is T-shaped and comprises thermoplastic polyurethane, and the comfort layer is a heat mat, the method comprising:
positioning the trim cover assembly and the comfort layer onto a seat cushion; and
attaching the tie down to the seat cushion.
